(19) United States
(12) Patent Application Publication
(10) Pub. No.: US 2010/0279907 A1
(43) Pub. Date: Nov. 4, 2010

(54) BOYS HYGIENE PRODUCTS SHAPED LIKE SPORTS BALLS

(76) Inventor: Marie C. Gelin, Fairburn, GA (US)

Correspondence Address: DONALD W. MEEKER, 924 EAST OCEAN FRONT, # E, NEWPORT BEACH, CA, 92661, US

(21) Appl. No.: 12/434,624

(22) Filed: May 2, 2009

(51) Int. Cl. C11D 9/00; C11D 17/00

(52) U.S. Cl. 510/129; 510/152

(57) ABSTRACT

Hygiene products for boys contain natural ingredients mild to the skin of boys. They have mild natural non-flowery scents. The boys hygiene products are in the shape of simulated sports balls sized to fit into a boys hand. A combination soap and shampoo is formed into a sports ball with a hole through it to receive an elasticized wrist loop therethrough. A boys butterball lotion is in the shape of simulated sports balls rubbed on the skin. A boys stick deodorant has a housing in the shape of a simulated sports ball. Team names and insignia may be applied to the surfaces of the simulated sports balls and the cords.

### CROSS-REFERENCE TO RELATED APPLICATIONS

Not Applicable.

### STATEMENT REGARDING FEDERALLY SPONSORED RESEARCH OR DEVELOPMENT

Not Applicable.

### THE NAMES OF THE PARTIES TO A JOINT RESEARCH OR DEVELOPMENT

Not Applicable.

### BACKGROUND OF THE INVENTION

1. Field of the Invention

The present invention relates to hygiene products and particularly to hygiene products for boys such as a combination soap/shampoo, a lotion, and a deodorant in the shape of a ball related to a sport wherein the hygiene products are fabricated of gentle natural ingredients milder than adult products and scented appropriately for boys and having a rope loop or elasticized band loop passing through a hole in the solid hygiene soap/lotion product with the loop going around the wrist of the boy so that the hygiene product is not dropped, wherein both the ball and wrist band may have names and insignia of sports teams on them.

2. Description of Related Art Including Information Disclosed Under 37 CFR 1.97 and 1.98

Today many boys spend most of their time playing their favorite sport. While they are highly involved and developing skills and agility and strength, they get pretty smelly and are not always interested in hygiene. There are many hygiene products for adults which contain ingredients which are too strong or harsh for children and teenagers. Adult hygiene products are often sized and shaped and scented inappropriately for children and teenagers and may not be easy to handle and use. Boys in particular are not very interested in products which might be considered sissy or girly products or boring adult products. Prior art hygiene products fail to solve all of these problems adequately.

U.S. Pat. No. D405,926, issued Feb. 16, 1999 to Badillo, illustrates the ornamental design for an assembly of a play ball for containing soap and attached children's wash cloth.

Three U.S. Pat. No. 6,720,296 issued Apr. 13, 2004, U.S. Pat. No. 6,455,478 issued Sep. 24, 2002, and U.S. Pat. No. 6,136,764 issued Oct. 24, 2000 to Bitton, provide a soap assembly comprising a transparent soap, an embedded toy, figurine or the like, and an embedded image layer. The soap assembly could also comprise a transparent soap with an embedded dissolvable image layer. The dissolvable image layer could be a liquid such that the toy, figurine or the like is floating within the image layer. As shown in FIG. 1, the ornamental figurine is a baseball player and the image layer a baseball.

U.S. Pat. No. D259,064, issued Apr. 28, 1981 to Lee, is for the ornamental design for a soap bar or similar article having a cord attached to one end.

U.S. Pat. No. 1,636,709, issued Jul. 26, 1927 to Schmidt, is for a bar of soap having a ribbon for hanging the bar.

U.S. Pat. No. 1,787,660, issued Jan. 6, 1931 to Blakeley, puts forth a hand-held soap including a finger-clasping band for holding the soap. The band is incorporated in the soap at time of soap manufacture.

U.S. Pat. No. D379,249, issued May 13, 1997 to Williams, shows the ornamental design for a combined soap and exfoliation pad with hanging cord.

U.S. Pat. No. D384,438, issued Sep. 30, 1997 to Hage, describes the ornamental design for a shampoo bar with string and hook fastener.

U.S. Pat. No. 1,416,962, issued May 23, 1922 to Meeks, shows a soap holder which comprises a strap having a loop at each end placed inside the bar of soap during manufacturing with the end loops protruding from the ends of the bar. A user would place a thumb through the first loop and a finger through the second loop to hold the bar of soap securely.

U.S. Pat. No. 2,099,484, issued Nov. 16, 1937 to Hokerk, indicates a toilet appliance which comprises a large bead of soap laced on a cord to be worn around a user's neck.

U.S. Pat. No. 2,182,293 issued Dec. 5, 1939 to Hokerk, relates a method of attaching a cord to soap.

U.S. Pat. No. 2,243,634, issued May 27, 1941 to Kadish, concerns a looped handle for securely holding a bar of soap. The end of the handle seats within an aperture in the bar of soap.

U.S. Pat. No. 2,883,791, issued Apr. 28, 1959 to Ballo, concerns a soap cake with a diamond-shaped aperture therethrough and an elastic band attached inside the aperture. The elastic cord may be stretched over the user's fingers for securely holding the bar of soap. When not in use, the cord is stored inside the aperture.

U.S. Pat. No. 3,160,523, issued Dec. 8, 1964 to Hull, presents a bathing appliance which comprises a bar of soap having a long string or cord incorporated therein which forms long looped handles so that a user may scrub their back with the bar of soap.

U.S. Pat. No. 3,341,457, issued Sep. 12, 1967 to Schmidt, claims a bar of soap having a strap therethrough. The ends of the strap are connected using a buckle to cause the strap to form a hand-encircling band.

U.S. Pat. No. 3,693,923, issued Sep. 26, 1972 to Ayoub et al, describes a suspension device for a cake of soap in the form of an elongated, flexible, polyethylene molded strip, which has pin engaging apertures at its outer ends and collars formed integrally therewith, and pins or inserts of acrylic resin for engaging in said apertures and for insertion into the side faces of the soap cake for retaining said cake soap and suspension loop in relative non-rotational position; and a wall bracket of polymerized methyl-methacrylate having an upright portion adapted to be adhesively attached to a wall over a wash basin or the like, such wall bracket having an upper, outwardly projecting hook arm and a lower, outwardly projecting drip pan, such hook when the suspension loop is hung therefrom holding such soap cake over said drip pan, in air, and out of contact with a moisture or water collecting vessel or surface.

U.S. Pat. No. 3,519,568, issued Jul. 7, 1970 to Needleman, puts forth a bar of soap having a loose rope extending from one side thereof.

U.S. Pat. No. 3,206,152, issued Sep. 14, 1965 to Wimmer, discloses a means for supporting or suspending soap. Each form of the invention uses an elastic strand with a cake of soap in which the elastic strand passes through the soap, coupled to a container for the soap, or embedded in the soap.

U.S. Pat. No. 3,251,571, issued May 17, 1966 to Ernest, indicates a soap holder and adjustable loop. An adjustable loop is provided that may be tightened around a bar of soap to hold it securely even as its size diminishes with use, using a tightening device or clamp with an opening for tightening purposes.

U.S. Pat. No. 3,796,665, issued Mar. 12, 1974 to Allen, provides a bar of soap having a cord for holding or hanging the bar.

U.S. Pat. No. 6,190,079, issued Feb. 20, 2001 to Ruff, illustrates a scrubbing soap bar that is composed of vegetable oil and glycerin within which is imbedded a length of a thin, fine mesh netting with a portion of the netting extending exteriorly of the soap bar. The portion of the netting that extends exteriorly of the soap bar forms a pocket which facilitates insertion of a human user's finger(s) which facilitates grasping and holding onto the soap bar as the soap bar is used.

U.S. Pat. No. 606,024, issued Jun. 21, 1898 to Peraglie et al, discloses a bar of soap having an anchor device embedded inside. A chain is provided which attaches to the anchor device on a first end and to the faucet of a sink on a second end.

U.S. Pat. No. 6,799,917, issued Oct. 5, 2004 to Sampson, claims a bar of soap with retention device includes a bar of soap with an aperture bored through it extending from the top surface to the bottom surface or from a first side edge to a second side edge. An elastic member attaches the bar of soap to a handling means through the aperture. The handling means includes an opening for attachment to the elastic member. The handling means is typically form as a ring but may have a series of finger indents within the opening or formed as a rod or handle. The elastic member is attached to the handling means by passing it through the opening in the handling means, passing both ends through the aperture and around each side of the bar and over the handling means to rest about the center of the elastic member. The retention device may be added to an existing bar of soap.

What is needed is hygiene products for boys with mild natural ingredients that are gentle to boys skin and mildly scented with natural non-flowery scents for boys with the boys hygiene products in the shape of a simulated sports ball sized to fit a boys hand.

### BRIEF SUMMARY OF THE INVENTION

An object of the present invention is to provide hygiene products for boys with mild natural ingredients that are gentle to boys skin and mildly scented with natural non-flowery scents for boys with the boys hygiene products in the shape of a simulated sports ball sized to fit a boys hand.

In brief, the present invention provides hygiene products for boys, such as a combination soap/shampoo, a lotion, and a deodorant in the shape of a ball related to a sport wherein the hygiene products are fabricated of gentle natural ingredients milder than adult products and scented appropriately for boys and having a rope loop or elasticized band loop passing through a hole in the solid hygiene soap/shampoo product with the loop going around the wrist of the boy so that the hygiene product is not dropped. Both the ball and wrist band may have names and insignia of sports teams on them.

A stick deodorant for boys fit removably in a housing in the shape of a simulated sports ball. The stick deodorant uses mild natural ingredients, which are gentle to boys skin and provide a mild natural non-flowery scent for boys preferably boys from the age group of 5-18.

The present invention teaches and promotes proper hygiene to young boys and young men encouraging boys to shower and stay moisturized with the intention that clean boys make healthy men.

### BRIEF DESCRIPTION OF THE SEVERAL VIEWS OF THE DRAWINGS

These and other details of my invention will be described in connection with the accompanying drawings, which are furnished only by way of illustration and not in limitation of the invention, and in which drawings:

FIG. 1 is a perspective view of a baseball shaped soap and shampoo boys hygiene product having an elasticized cord looped through a hole through the ball and a team insignia on the ball and cord;

FIG. 2 is a perspective view of a football shaped soap and shampoo boys hygiene product having an elasticized cord looped through a hole through the ball;

FIG. 3 is a perspective view of a basketball shaped soap and shampoo boys hygiene product having an elasticized cord looped through a hole through the ball;

FIG. 4 is a perspective view of a soccer ball shaped soap and shampoo boys hygiene product having an elasticized cord looped through a hole through the ball;

FIG. 5 is a perspective view of a tennis ball shaped soap and shampoo boys hygiene product having an elasticized cord looped through a hole through the ball;

FIG. 6 is a perspective view of a golf ball shaped soap and shampoo boys hygiene product having an elasticized cord looped through a hole through the ball;

FIG. 7 is a perspective view of a baseball shaped butterball lotion boys hygiene product having a team insignia on the ball;

FIG. 8 is a perspective view of a football shaped butterball lotion boys hygiene product;

FIG. 9 is a perspective view of a basketball shaped butterball lotion boys hygiene product;

FIG. 10 is a perspective view of a soccer ball shaped butterball lotion boys hygiene product;

FIG. 11 is a perspective view of a tennis ball shaped butterball lotion boys hygiene product;

FIG. 12 is a perspective view of a golf ball shaped butterball lotion boys hygiene product;

FIG. 13 is an exploded perspective view of a boys hygiene deodorant product having a boys deodorant stick aligned for removable insertion inside a baseball shaped deodorant housing;

FIG. 14 is a perspective view of a boys hygiene deodorant product having a boys deodorant stick inserted within a baseball shaped deodorant housing having a related team insignia on the housing;

FIG. 15 is a perspective view of a boys hygiene deodorant product having a boys deodorant stick inserted within a football shaped deodorant housing;

FIG. 16 is a perspective view of a a boys hygiene deodorant product having a boys deodorant stick inserted within a basketball shaped deodorant housing;

FIG. 17 is a perspective view of a boys hygiene deodorant product having a boys deodorant stick inserted within a soccer ball shaped deodorant housing;

FIG. 18 is a perspective view of a boys hygiene deodorant product having a boys deodorant stick inserted within a tennis ball shaped deodorant housing;

FIG. 19 is a perspective view of a boys hygiene deodorant product having a boys deodorant stick inserted within a golf ball shaped deodorant housing.

### DETAILED DESCRIPTION OF THE INVENTION

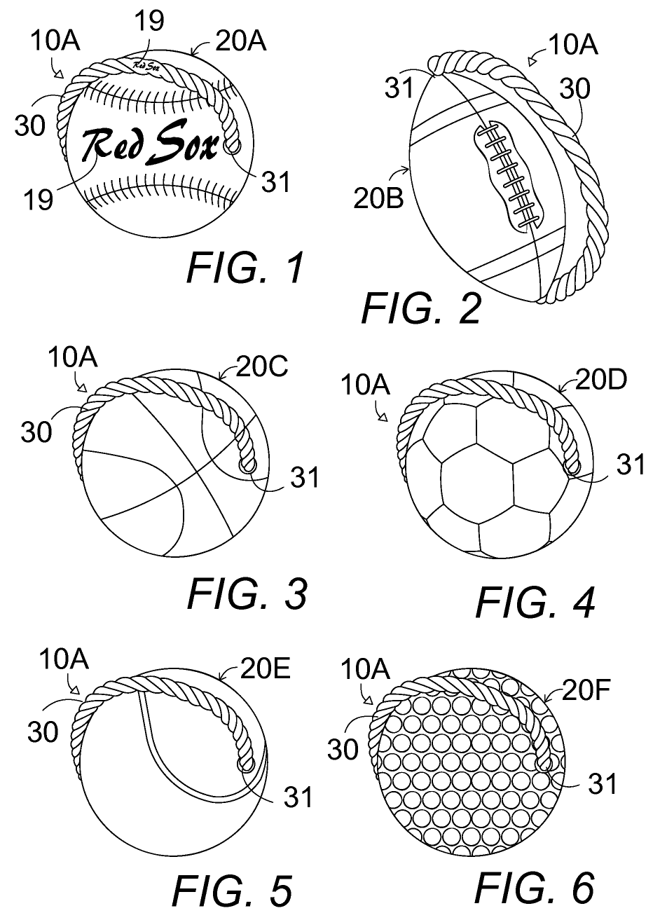

In FIGS. 1-19, a boys hygiene product 10A, 10B, and 10C comprises a boys combined soap and shampoo 20A-20F in FIGS. 1-6, a boys butter ball lotion 40A-40F, and a boys deodorant 60A-60F all formed with mild natural ingredients and mild scents for boys skin and all having the shape of sports balls.

The boys hygiene product 10A, 10B, and 10C comprising a simulated sports ball 20A-20F, 40A-40F, and 60A-60F to fit in a boy's hand for applying the hygiene product to the body of the boy, the simulated sports ball being smaller than adult products. The simulated sports ball containing non-caustic mild skin soothing ingredients for use on a boy's body to sooth and not irritate a boy's sensitive skin and containing a mild scent less strong than adult scented hygiene products so that the scent is aromatically soothing and not overpowering to a boy's sense of smell which is more sensitive than an adult's sense of smell, the scent being a non-flowery scent appealing to a boy.

The boys hygiene product contains a mixture of mild to the skin ingredients found in nature rather than harsh synthetic ingredients, preferably organic ingredients.

In FIGS. 1-6, the ingredients comprise combined natural soap and shampoo ingredients molded in the shape of a simulated sports ball 20A-20F sized to fit in a palm of a boy's hand. Each of the simulated sports balls 20A-20F has a hole 31 bored through the simulated sports ball and an elasticized cord loop 30 extending through the hole and around an outside surface of the simulated sports ball in close proximity to the outside surface of the simulated sports ball so that the cord may be wrapped around a wrist of the boy while holding the simulated sports ball in a palm of a hand of the boy, the cord securing the simulated sports ball in the palm of the boy while using the combined soap and shampoo simulated sports ball 20A-20F for shampooing the boy's hair and washing the boy's skin.

In FIG. 1, the combined soap and shampoo boys hygiene product 10A comprises a simulated baseball 20A having an elasticized cord 30 looped through a hole 31 through the ball and an external visible image related to a team associated with the combined soap and shampoo containing simulated sports ball shape, such as a team insignia 19 on the ball and cord.

In FIG. 2, the combined soap and shampoo boys hygiene product 10A comprises a simulated football 20B having an elasticized cord 30 looped through a hole 31 through the ball.

In FIG. 3, the combined soap and shampoo boys hygiene product 10A comprises a simulated basketball 20B having an elasticized cord 30 looped through a hole 31 through the ball.

In FIG. 4, the combined soap and shampoo boys hygiene product 10A comprises a simulated soccer ball 20B having an elasticized cord 30 looped through a hole 31 through the ball.

In FIG. 5, the combined soap and shampoo boys hygiene product 10A comprises a simulated tennis ball 20B having an elasticized cord 30 looped through a hole 31 through the ball.

In FIG. 6, the combined soap and shampoo boys hygiene product 10A comprises a simulated golf ball 20B having an elasticized cord 30 looped through a hole 31 through the ball.

The combined soap and shampoo containing sports ball 20A-20F comprises a combination of at least three of the ingredients taken from the list of ingredients including organic aloe, Montana aloe, comfrey chocolate extract, oats, extra virgin oils, palm oils, sodium hydroxide, hemp, root extract, cucumber juice, honey, carrot root, black seed oil, mint herbs, olive goat milk, distilled water, coconut oils, herbal essence, glycerin, and mild natural scent such as sandalwood scent.

The boys combined soap and shampoo containing sports ball 20A-20F generally contains 6%-7% superfat for a moisturizing effect and contains saponified oils of coconut, black cumin, castor, olive, palm, palm kernel, palm stearic, and jojoba with oat protein, panthenol and vitamin E.

The boys combined soap and shampoo containing sports ball 20A-20F preferably comprises a combination of equal parts of black cumin oil, castor oil, olive oil, and palm oils (14.28% of entire contents each), 76 degree coconut oil (21.43% of entire content), palm kernel (9.55% of entire content), palm stearic (4.76% of entire content), jojoba (7.14% of entire content), one tablespoon of Vitamin E per pound of oils, liquid hydrolized oat protein (2% of the combined weight of the oils), liquid hydrolized panthenol (2% of the combined weight of the oils), distilled water (28% of the combined weight of the oils), and liquid sodium hydroxide (lye) (13.5% of the combined weight of the oils).

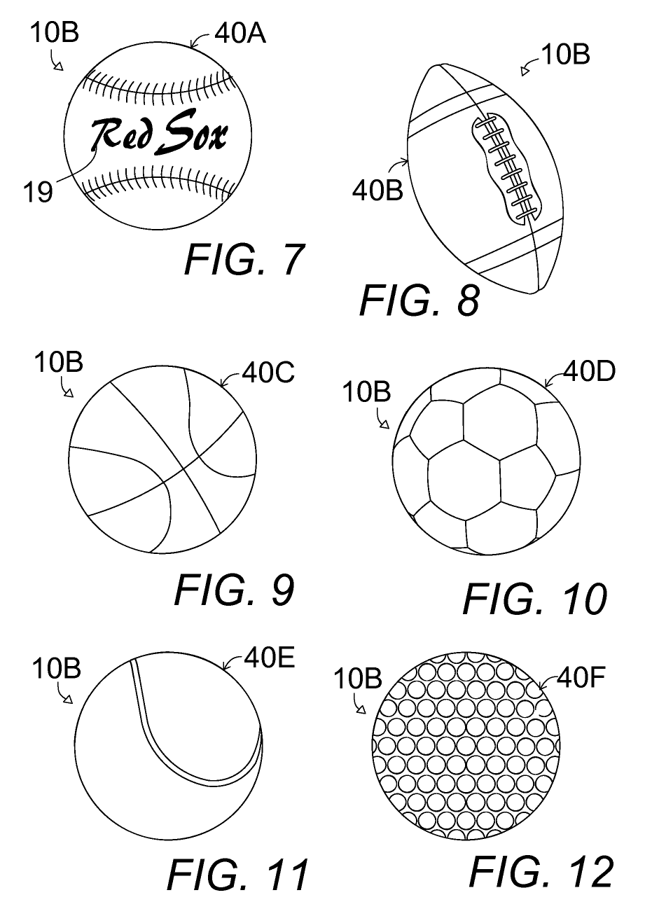

In FIGS. 7-12, the boys hygiene product 10B comprises a simulated sports ball 40A-40F formed using a skin soothing and moisturizing lotion containing natural skin soothing and moisturizing ingredients molded in the shape of a butterball lotion simulated sports ball 40A-40F sized to fit in a palm of a boy's hand. The simulated sports ball 40A-40F preferably comprises a solid lotions bar comprising at least one of the oils taken from the list of oils including black cumin seed oil, olive oil, palm oil, and coconut oil. The lotion containing simulated sports ball 40A-40F is held in the palm of the boy while using the simulated sports ball for applying the lotion to the boy's skin by rubbing the lotion containing simulated sports ball against the boy's skin. An external visible image, such as a team insignia 19 related to the shape of the ball, is visible on the surface of the lotion containing simulated sports ball, as shown in FIG. 7. The butterball lotion simulated sports ball may comprise any shaped sports ball, such as a baseball 40A in FIG. 7, a football 40B in FIG. 8, a basketball 40C in FIG. 9, a soccer ball 40D in FIG. 10, a tennis ball 40E in FIG. 11, or a golf ball 40F in FIG. 12.

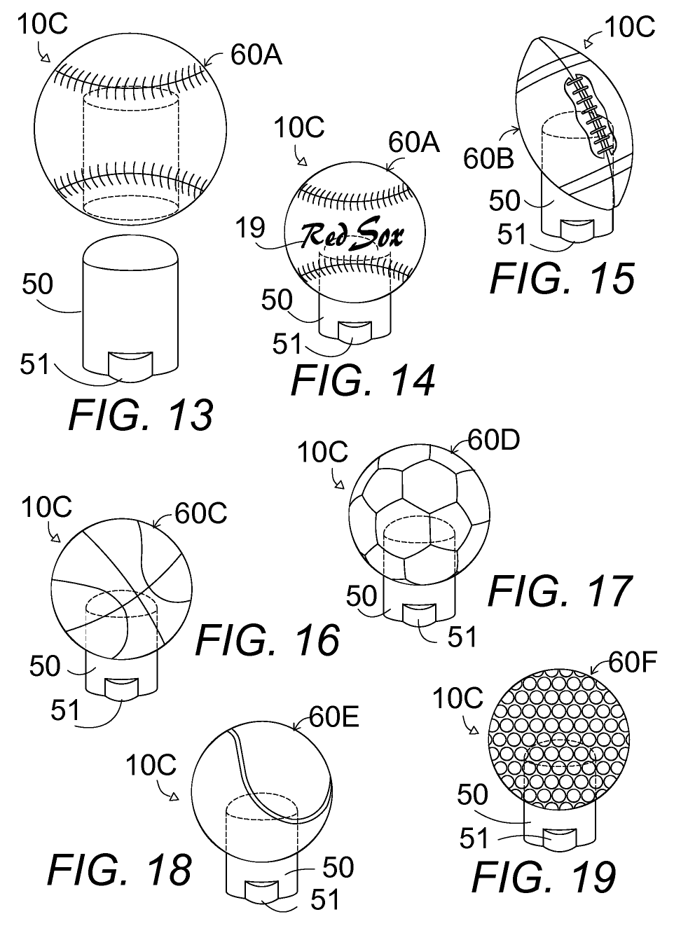

In FIGS. 13-19, the boys hygiene product 10C comprises a boys deodorant product in the form of a stick deodorant 50, with an optional stick advancer 51, having a low pH below adult deodorant pH levels and a non-flowery mild scent, the stick deodorant slidably housed inside a simulated sports ball container 60A-60F, such as a baseball 60A in FIGS. 13 and 14, a football 60B in FIG. 15, a basketball 60C in FIG. 16, a soccer ball 60D in FIG. 17, a tennis ball 60E in FIG. 18, a golf ball 60F in FIG. 19 or any other simulated sports ball shape, which may have an external visible image, such as a team insignia 19, related to a team associated with the simulated sports ball container shape.

All of the boys hygiene products 10A, 10B, and 10C contain mild natural ingredients, preferably organic ingredients all kind to the skin of a boy and mild scents, preferably natural scents, such as sandalwood, which are not strong scented and not flowery scented.

It is understood that the preceding description is given merely by way of illustration and not in limitation of the invention and that various modifications may be made thereto without departing from the spirit of the invention as claimed.

What is claimed is:

1. A boys hygiene product comprising:
a boys hygiene product comprising a simulated sports ball to fit in a boy's hand for applying the hygiene product to the body of the boy, the simulated sports ball being smaller than adult products, the simulated sports ball containing non-caustic mild skin soothing ingredients for use on a boy's body to sooth and not irritate a boy's sensitive skin and containing a mild scent less strong than adult scented hygiene products so that the scent is aromatically soothing and not overpowering to a boy's sense of smell which is more sensitive than an adult's sense of smell, the scent being a non-flowery scent appealing to a boy.

2. The boys hygiene product of claim 1 wherein the hygiene product contains a mixture of ingredients found in nature rather than synthetic ingredients.

3. The boys hygiene product of claim 2 wherein the hygiene product contains organic ingredients.

4. The boys hygiene product of claim 1 wherein the ingredients comprise combined natural soap and shampoo ingredients molded in the shape of a simulated sports ball sized to fit in a palm of a boy's hand having a hole bored through the simulated sports ball and an elasticized cord loop extending through the hole and around an outside surface of the simulated sports ball in close proximity to the outside surface of the simulated sports ball so that the cord may be wrapped around a wrist of the boy while holding the simulated sports ball in a palm of a hand of the boy, the cord securing the simulated sports ball in the palm of the boy while using the simulated sports ball for shampooing the boy's hair and washing the boy's skin.

5. The boys hygiene product of claim 4 wherein the combined soap and shampoo containing simulated sports ball has an external visible image related to a team associated with the combined soap and shampoo containing simulated sports ball shape.

6. The boys hygiene product of claim 4 wherein the cord has an external visible image related to a team associated with the combined soap and shampoo containing simulated sports ball shape.

7. The boys hygiene product of claim 4 wherein the simulated sports ball contains 6%-7% superfat for a moisturizing effect.

8. The boys hygiene product of claim 4 wherein the simulated sports ball contains saponified oils of coconut, black cumin, castor, olive, palm, palm kernel, palm stearic, and jojoba with oat protein, panthenol and vitamin E.

9. The boys hygiene product of claim 4 wherein the combined soap and shampoo containing simulated sports ball comprises a combination of at least three of the ingredients taken from the list of ingredients including organic aloe, Montana aloe, comfrey chocolate extract, oats, extra virgin oils, palm oils, sodium hydroxide, hemp, root extract, cucumber juice, honey, carrot root, black seed oil, mint herbs, olive goat milk, distilled water, coconut oils, herbal essence, glycerin, a mild natural scent, and sandalwood scent.

10. The boys hygiene product of claim 4 wherein the combined soap and shampoo containing sports ball comprises a combination of equal parts of black cumin oil, castor oil, olive oil, and palm oils (14.28% of entire contents each), 76 degree coconut oil (21.43% of entire content), palm kernel (9.55% of entire content), palm stearic (4.76% of entire content), jojoba (7.14% of entire content), one tablespoon of Vitamin E per pound of oils, liquid hydrolized oat protein (2% of the combined weight of the oils), liquid hydrolized panthenol (2% of the combined weight of the oils), distilled water (28% of the combined weight of the oils), and liquid sodium hydroxide (lye) (13.5% of the combined weight of the oils).

11. The boys hygiene product of claim 1 comprising a boys deodorant product in the form of a stick deodorant having a low pH below adult deodorant pH levels and a non-flowery mild scent, the stick deodorant slidably housed inside a simulated sports ball container.

12. The boys hygiene product of claim 11 wherein the simulated sports ball container has an external visible image related to a team associated with the simulated sports ball container shape.

13. The boys hygiene product of claim 1 wherein the simulated sports ball comprises a skin soothing and moisturizing lotion containing natural skin soothing and moisturizing ingredients molded in the shape of a simulated sports ball sized to fit in a palm of a boy's hand, the lotion containing simulated sports ball held in the palm of the boy while using the simulated sports ball for applying the lotion to the boy's skin by rubbing the lotion containing simulated sports ball against the boy's skin.

14. The boys hygiene product of claim 13 wherein the lotion containing simulated sports ball has an external visible image on the surface of the lotion containing simulated sports ball related to a team associated with the lotion containing simulated sports ball shape.

15. The boys hygiene product of claim 13 wherein the simulated sports ball comprises a solid lotions bar comprising at least one of the oils taken from the list of oils including black cumin seed oil, olive oil, palm oil, and coconut oil.
